(19) United States
(12) Patent Application Publication
(10) Pub. No.: US 2010/0289880 A1
(43) Pub. Date: Nov. 18, 2010

(54) Driver for Display Comprising a Pair of Binocular-Type Spectacles

(76) Inventors: Renaud Moliton, Charenton-le-Pont (FR); Cécile Bonafos, Paris (FR)

Correspondence Address: SOFER & HAROUN LLP., 317 MADISON AVENUE, SUITE 910, NEW YORK, NY, 10017, US

(21) Appl. No.: 12/225,363

(22) PCT Filed: Apr. 26, 2007
(86) PCT No.: PCT/FR2007/051177

§ 371 Date: Sep. 18, 2008

(30) Foreign Application Priority Data
Apr. 26, 2006 (FR) 0651481

(51) Int. Cl. H04N 13/02; H04N 13/04

(52) U.S. Cl. 348/47; 348/53; 348/E13.074; 348/E13.075

(57) ABSTRACT

The invention relates to a driver (P) for driving miniature screens of a binocular display (A) that comprises, for each eye of the wearer, a respective optical imager (1, 2) for shaping light beams corresponding to an image (IE) of determined surface area delivered by a said miniature screen (3, 4) and for directing them to the eye of the wearer so as to enable information content contained in a virtual image (I1, I2) to be viewed. According to the invention, it is placed in a unit and provided with:
a first connection (P1) for communication with a computer (O, 20) having memory storing compensation parameters necessary for shifting the images delivered by the screens so as to obtain an adjusted position for said images on said screens corresponding to the two virtual images (I1, I2) being superposed;
a second connection (P2) for inputting data coming from an image source (S); and
a third connection (P3) connecting to said right and left screens of the display (A).

The present invention relates to a driver for a display comprising a pair of eyeglasses of binocular type and fitted with an optical imager for each eye in order to enable information of image or multimedia type to be projected.

The term “binocular” designates a display that provides a virtual image for each eye of the wearer.

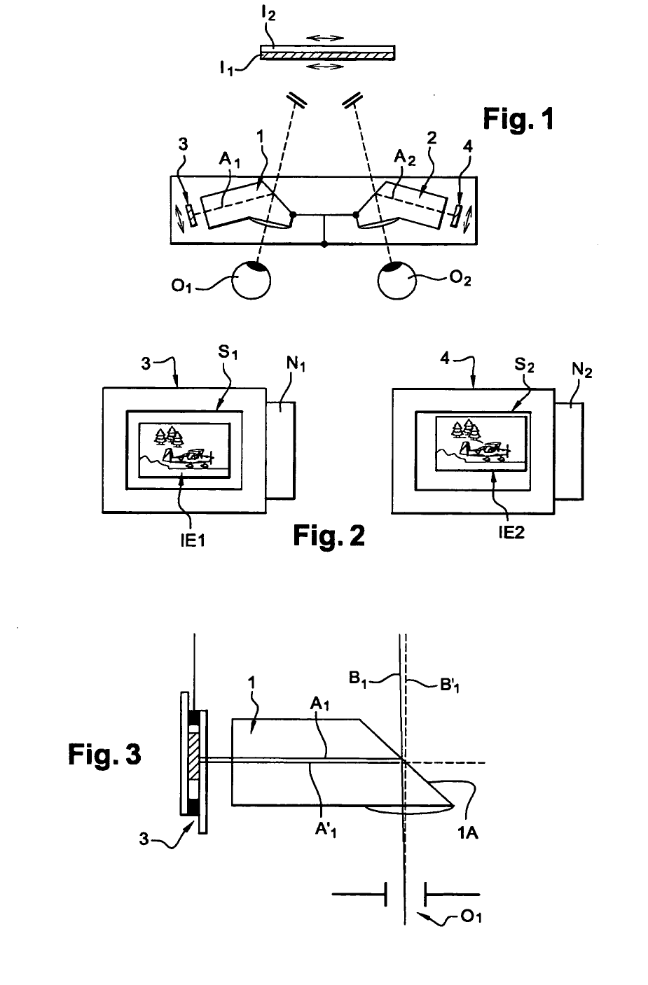

Such a binocular display is known and shown in FIG. 1.

In that display, the optical imagers 1, 2 serve to shape light beams coming from reflective electronic and optical systems for generating light beams by means of miniature screens 3, 4. Each optical imager directs light beams towards the corresponding eye O1, O2 of the wearer so as to enable the information content to be viewed.

In such a display, an electronic signal conveying information is delivered to each miniature screen by a cable. On the basis of this signal, each miniature screen, lighted by a background light source, generates a pixel image corresponding to the information. By way of example, it is possible to use a “KOPIN Cyberdisplay 320 color” screen that generates 320×240 pixel images with dimensions of 4.8 millimeters (mm) by 3.6 mm. The screens are put into reference positions relative to the optical imagers by means of mechanical interfaces. A protective shell protects all or part of the assembly.

For good viewing with such a display, it is important for the image I1 seen by the left eye to be superposed on the image I2 seen by the right eye.

At present, in order to align these right and left images in a binocular display, during assembly a step is performed that consists in physically shifting the miniature screens 3, 4 perpendicularly to the optical axes A1, A2 of the imagers so as to move at least one of the virtual images in corresponding manner in order to bring the right and left images into superposition.

More precisely, that known alignment principle consists in fixing the position of the first screen, e.g. the left screen 3 relative to the left imager 1, typically by means of adhesive, and then in moving the right screen 4 perpendicularly to the optical axis A2 of the right imager so as to bring the right image into coincidence with the left image, and once this has been done, the screen is blocked in the aligned position by means of adhesive.

That solution requires shells or housings to be designed that enable the miniature screens to be shifted transversely for this adjustment, and it also requires a system for temporarily holding a screen prior to its position being fixed permanently by adhesive.

That method requires a step that is lengthy and difficult from the manipulation point of view, which in practice means that it is difficult to obtain good efficiency.

A system could be envisaged for aligning the right and left images that does not require any physical shifting of the miniature screens and that therefore presents the advantage of enabling a simpler casing to be arranged, while also making the alignment step simpler and more reliable during the assembly and adjustment process.

Under such circumstances, the miniature screens present active surface areas that are greater than said determined surface area for the image that is delivered, and the method of adjusting the display then consists in shifting the delivered image electronically over the screen so as to obtain an adjusted position for the image on the screen that corresponds to the two virtual images being superposed.

The binocular display preferably includes an imager integrated in each lens of a pair of eyeglasses for receiving light beams from a beam generator device comprising respective said miniature screens.

That type of arrangement is particularly advantageous in this application.

Since each of the generator devices comprises a portion of the optical system and a screen, they can be as small as possible since there is no need for them to incorporate any mechanical system for transversely adjusting the position of the miniature screen.

The advantage of shifting the image electronically is that it can be done with a cover that is closed, and thus at the last moment, and in an environment that is not constricting, since it does not require tools or clean-room precautions.

Another advantage is that there is no need to touch the system physically during adjustment, thereby reducing errors and increasing the speed with which convergence is achieved in fusion adjustment. Fusion adjustment is thus made more reliable.

In order to maximize the comfort of the wearer of such a display, it is preferable for this adjustment to be performed for each wearer to match that wearer's own optical characteristics, and in particular each wearer's pupillary distance.

The invention thus provides a driver for driving miniature screens of a binocular display that comprises, for each eye of the wearer, a respective optical imager for shaping light beams corresponding to an image of determined surface area delivered by a said miniature screen and for directing them to the eye of the wearer so as to enable information content contained in a virtual image to be viewed, the driver being characterized in that it is placed in a unit provided with:
a first connection for communication with a computer having memory storing compensation parameters necessary for shifting the images delivered by the screens so as to obtain an adjusted position for said images on said screens corresponding to the two virtual images being superposed;
a second connection for inputting data coming from an image source; and
a third connection connecting to said right and left screens of the display.

Such a driver or control unit acts in an adjustment situation with an installer to form an interface between a computer that supplies it with the compensation parameters as defined by means of an adjustment bench and the miniature screens of the display and it also acts in an in-use situation on a wearer to form an interface between an image source and the display. The driver thus makes it easy to modify the adjustment of the miniature screens to match a wearer, so as to obtain perfect alignment of the virtual images.

In a preferred embodiment of the invention, the driver comprises a compensation circuit and an offset circuit for shifting the display of an image transmitted from said source to the display circuit of said screen.

Preferably, said compensation circuit comprises a CPU performing a compensation management function consisting in storing in memory said compensation parameters together with parameters of formulas for calculating said compensation parameters.

Advantageously, said CPU checks said compensation parameters for error and corrects them.

Said CPU may also perform a video looping function consisting in generating a stationary test image previously stored in the driver by said computer.

Advantageously, the compensation parameters stored in memory are associated with a user identifier in a personalized compensation profile.

Preferably, said offset circuit comprises a GPU performing an image processing function that continuously shifts the image electronically in real time.

Said image processing function may consist in performing image rotation specific to each miniature screen and image shifting specific to each miniature screen.

Said image processing function may also include image de-interlacing common to both miniature screens.

Preferably, the driver of the invention includes a man/machine interface enabling a user to select a personalized compensation profile.

Said man/machine interface may enable a user to select a de-interlacing mode.

The invention also provides a method of determining said compensation parameters needed for shifting the images delivered by the screens, the method consisting in recording said compensation parameters in said driver as specified above, and being characterized in that it consists in using at least one or two cameras that can be positioned so that the entry pupil(s) of the objective lens(es) thereof lie in the vicinity of the positions of the pupils of respective eyes of the wearer.

Preferably, the method includes a first step of calibration consisting in storing in memory the calibration coordinates of the center of a target relative to the optical axis of each camera.

Two cameras may be used, and in that it may include a prior step of converging the optical axes of said cameras on said common target.

The method may consist in installing said display in front of said cameras, each of the two miniature screens delivering a said image of determined surface area, and the method comprising the following steps for each camera:
acquiring the image;
calculating the center of the image; and
calculating the correction vector present between said image center and the optical axis of the camera, taking account of said calibration coordinates.

Said apparatus may comprise a computer controlling an alignment bench for connection to said driver.

Finally, the invention provides a binocular display comprising, for each eye of the wearer, an optical imager for shaping light beams corresponding to an image of determined surface area delivered by a respective one of said miniature screens, and for directing the light beams towards each eye of the wearer in order to enable information content contained in a virtual image to be viewed, the display being characterized in that it is associated with a driver as specified above.

Preferably, the display includes an imager integrated in each lens of a pair of eyeglasses and receiving light beams from respective beam generator devices, each comprising a said miniature screen.

The invention is described below in greater detail with the help of figures that merely show a preferred embodiment of the invention.

FIG. 1, is described above and is a plan view of a known display.

FIG. 2 is a face view of two miniature screens in accordance with the invention.

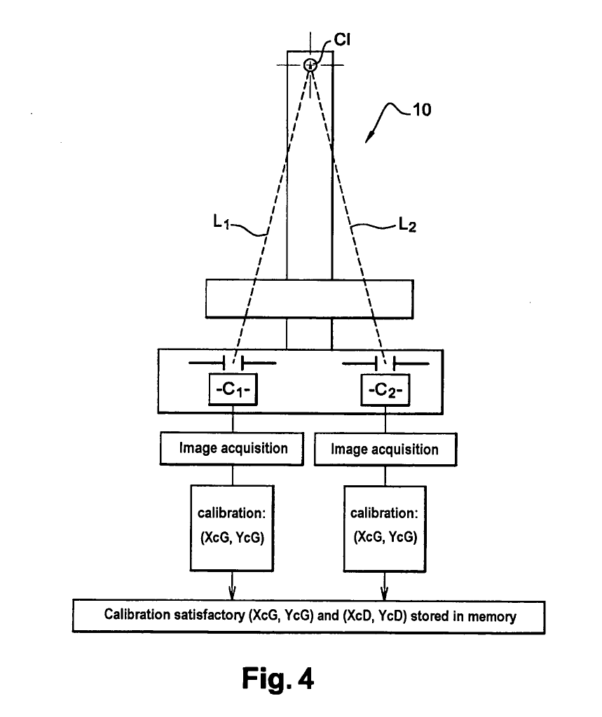

FIG. 3 is a plan view of an imager and a miniature screen in accordance with the invention.

FIG. 4 is a plan view of an adjustment bench for implementing the method in accordance with the invention.

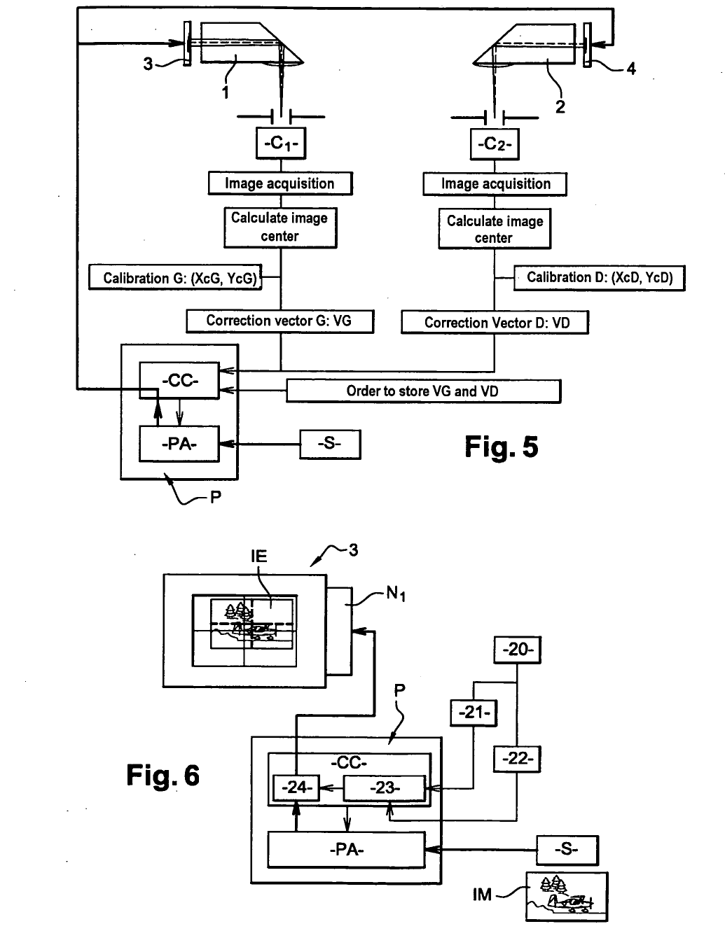

FIG. 5 represents an alignment algorithm protocol for implementing the method in accordance with the invention.

FIG. 6 is a block diagram of the hardware for implementing the protocol.

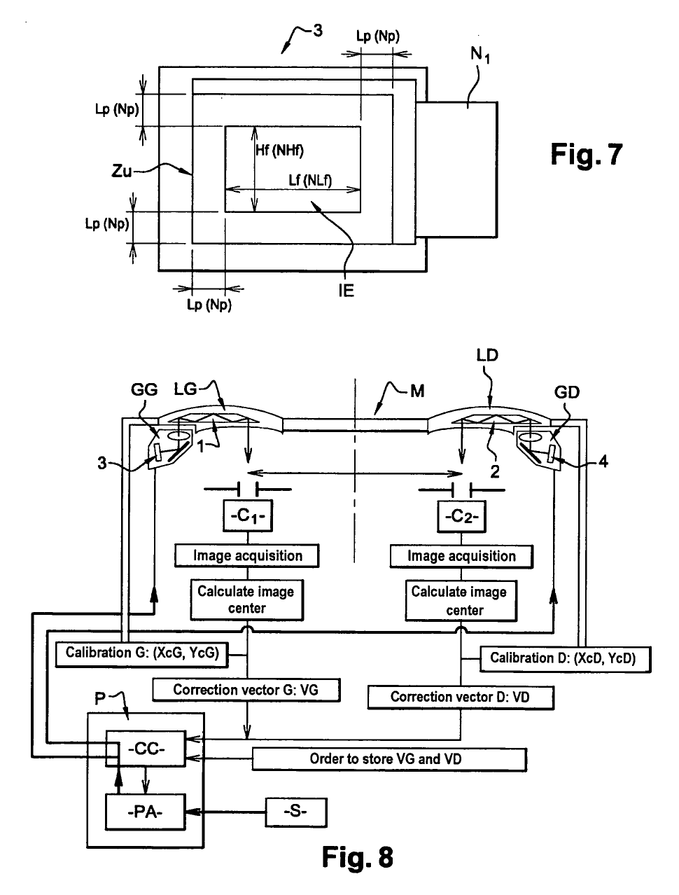

FIG. 7 is a face view of a miniature screen in accordance with the invention.

FIG. 8 represents the alignment algorithm protocol for implementing the method in accordance with the invention using another type of binocular display.

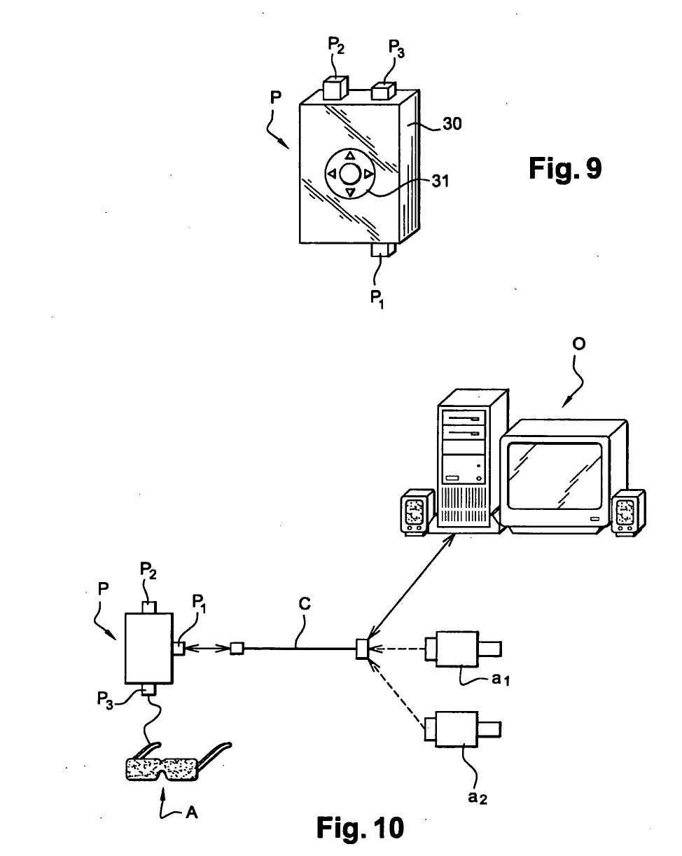

FIG. 9 is a perspective view of a driver unit in accordance with the invention.

FIG. 10 is a diagram of the driver and its connections.

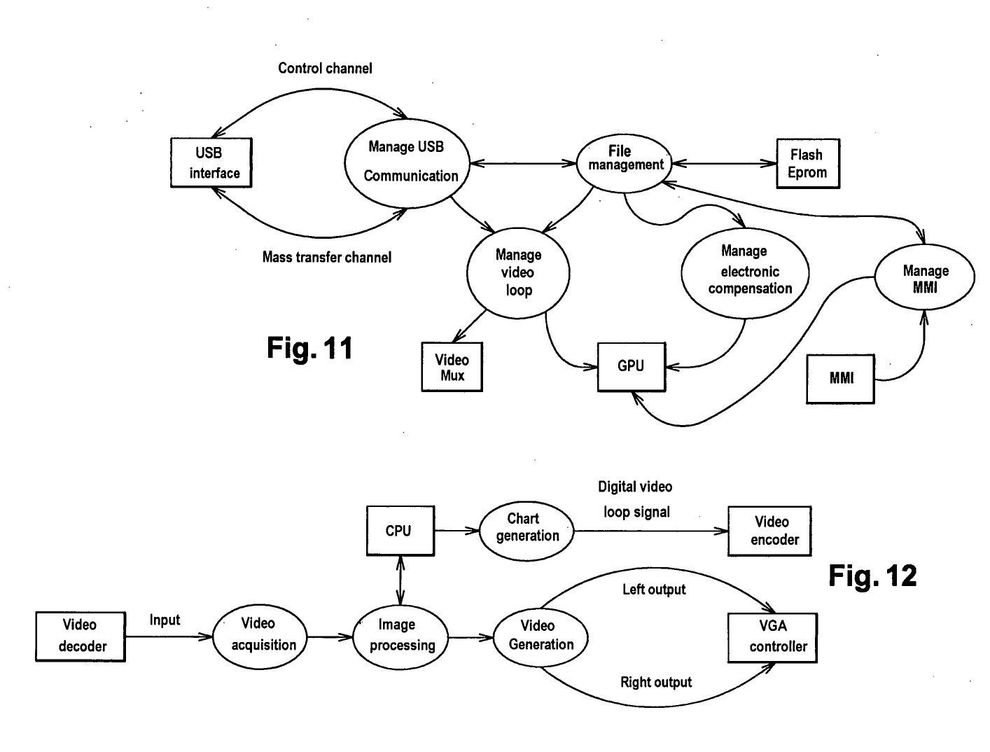

FIG. 11 is a diagram showing data streams of a CPU forming part of the driver.

FIG. 12 is a diagram of the data streams of a GPU forming part of the driver.

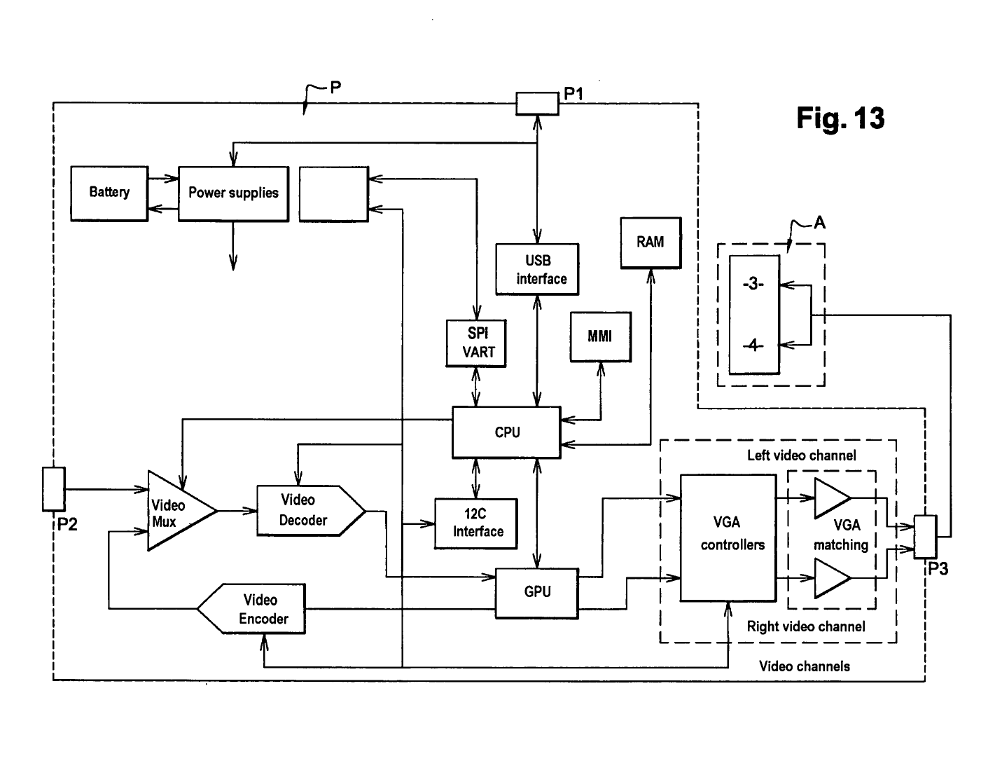

FIG. 13 is an electronic block diagram of the driver in accordance with the invention.

FIG. 2 illustrates the general concept of the invention.

A binocular type display in accordance with the invention comprises, for each eye of the wearer, an optical imager 1, 2 for shaping light beams corresponding to an image of determined surface area IE1, IE2 as delivered by respective stationary miniature screens 3, 4, each provided with a display driver, e.g. connected via a respective addressing ribbon N1, N2, and for directing the beams to the respective eye O1, O2 of the wearer so as to enable information content to be viewed that is contained in a virtual image I1, I2.

In the invention, at least one of said miniature screens, and preferably both screens 3 and 4, presents an active surface S1, S2 of area greater than the determined area of the image IE1, IE2 as delivered. BY way of example, in order to display an image of 640×480 pixels, it is possible to use a screen having an active area equal to 690×530 pixels, i.e. with 50 extra pixels around the determined area of the image.

In FIG. 2, the image IE1 delivered by the left screen 3 is centered on the active area S1 of the screen 3, while the image IE2 delivered by the right screen 4 is offset away from the center position.

The adjustment method in accordance with the invention as applied to such a display consists in moving the delivered image IE over the screen so as to obtain an adjusted position for said image on said screen that corresponds to the right and left virtual images I1 and I2 being superposed.

This method is illustrated in FIG. 3.

This figure shows the optical axis A′1 corresponding to an image delivered from the center of the miniature screen 3. After processing by an optical arrangement, such as a mirror 1A, these light beams are directed towards the eye O1 of the wearer, and a virtual image is visible that is centered on the axis B′1.

It can be seen that by moving the image as delivered by the screen, preferably transversely relative to the optical axis A1, the resulting virtual image is moved and centered on the axis B1. In other words, the position in space and the display angle to the center of the virtual image are modified.

Thus, by moving the image that is delivered by the screen, the resulting virtual image is caused to move in substantially equivalent manner, so the method serves to adjust the right and left images obtained by using a binocular display in such a manner as to obtain optimum fusion or superposition thereof.

FIG. 4 shows an adjustment bench for implementing the method in accordance with the invention.

Initially, the method consists in simulating each eye by means of a camera C1, C2, and comprises a first step of calibration consisting in:
causing the optical axes L1, L2 of the cameras to converge on a common target CI; and
storing in memory the calibration coordinates for the center of said target CI relative to the optical axis of each camera.

An alignment bench 10 is initially calibrated by causing the optical axes of the right and left cameras C1 and C2 to converge on the convergence target CI. This adjustment is obtained by means of appropriate opto-mechanical devices and by image acquisition performed by the cameras. An algorithm is used to detect the pattern of the test chart CI and its center coordinates are extracted therefrom and written (XcG, YcG) for the left camera and (XcD, YcD) for the right camera. The system is properly adjusted when these coordinates are as close as possible to the point (0,0). It is possible to determine the accuracy of the adjustment of the opto-mechanical system as expressed in pixels: this data is obtained either by calculating opto-mechanical tolerances, or by practical experiments using protocols known to the person skilled in the art.

Accuracy on the X axis is written Xp and on the Y axis it is written Yp, in both cases expressed in pixels on the detectors of the cameras. It is considered that the bench is well calibrated when XcG and XcD are less than Xp, and when YcG and YcD are less than Yp.

This adjustment accuracy should be selected in such a manner as to guarantee that the virtual images fuse well. The fusion adjustment bench must therefore necessarily be such that:

2·Pitch_camera·(Xp²+Yp²)̂(½)/EFL(camera)=angular tolerance of final fusion/N

where:

EFL(camera) is the effective focal length of the camera;

“Pitch_camera” is the size of a camera pixel; and

1/N is the fraction of the total tolerance budget that is to be consumed for this purpose, e.g. ½.

Preferably, the bench and its adjustments are designed so that the final sensitivity of the adjustment is less than or equal to 1 pixel.

A computer then stores in memory the coordinates (XcG, YcG) and (XcD, YcD). These coordinates then designate the virtual points towards which the binocular adjustments are to converge.

An alternative principle would be to use only one camera and to move in it translation between a right position and a left position. The same camera is then moved in translation through a known distance between the right and left positions.

There is then no need to align on a convergence target, since the corresponding values (XcG, YcG) and (XcD, YcD) correspond directly to the position of the image of the target on the camera, the optical axis of the camera being adjusted independently to the perpendicular to the direction in which it is moved in translation, and the target being positioned on the perpendicular bisector of the segment formed by the two camera positions.

An alternative principle would be to use only one camera and a system of calibrated mirrors and prisms for combining the right and left images in a single image.

In a second stage, the method consists in installing the display in front of the cameras C1 and C2, with each of the two miniature screens 3, 4 delivering an image of determined surface area, this stage comprising the following steps for each camera:
acquiring the image;
calculating the center of said image;
calculating the correction vector present between the center of the image and the optical axis of the camera, taking account of said calibration coordinates; and
recording the correction vectors in a compensation circuit of the display driver for each miniature screen of the display.

FIG. 5 represents this alignment algorithm protocol.

The mechanical structure of the alignment bench, and the way the display is assembled ensure that the axes X and Y of the miniature screens 3 and 4 and of the detectors of the cameras C1 and C2 are respectively in alignment, assuming an optical axis to be unfolded.

During the alignment procedure, an image is displayed on each of the right and left screens 3 and 4, which image is supplied by an image source S and acts as an alignment target. Preferably the shape of the image is specially designed for this purpose, e.g. comprising a cross occupying the center of the image.

The cameras C1 and C2 are used to acquire the image on each of the right and left channels. Thereafter, the position of the center of the cross is identified either manually or automatically using an image-processing algorithm. These positions for the left and right images are written (XiG, YiG), and (XiD, YiD).

Thereafter, the program calculates the following vectors in simple manner:

VG_{—}a=(XiG−XcG,YiG−YcG)

VD_{—}a=(XiD−XcD,YiD−YcD)

Thereafter, it calculates the compensation or correction vectors VD and VG for the left and right images as follows:

VG=−[(XiG−XcG)·RxG,(YiG−YcG)·RyG]

VD=−[(XiD−XcD)·RxD,(YiD−YcD)·RyD]

where RxG and RxD are the magnification ratios for a pixel of the miniature screen on a pixel of the detector of the camera along the axis X, respectively for the left camera and for the right camera.

It should be observed that generally the absolute value of the magnification along the X axis and the magnification along the Y axis are sufficiently close to each other to be considered as being identical.

In contrast, the signs of these two magnitudes may be different, particularly when the optical system of the binocular eyeglasses, i.e. the imager 1, 2, contains mirrors.

The following are then defined:
“signX” is the sign of the horizontal transverse magnification that depends on the optical combination and that it is important to take into account in calculating the compensation vector. This sign is determined by knowledge of the optical combination;
“signY” is the sign of the vertical transverse magnification that depends on the optical combination and that it is important to take into account in calculating the compensation vector. This sign is determined by knowledge of the optical combination.

These values are then expressed in the following form:

RxG=RG·signX and respectively RxD=RD·signX

RyG=RG·signY and respectively RyD=RD·signY

where R is the magnification ratio of a pixel of the miniature screen over a pixel of the detector of the camera, with RG and RD designating the respective values thereof for the left camera and for the right camera. A good way of evaluating it is to take an average over the entire image:

R=Rx=(width of the image in pixels on the miniature screen)/(width of the image in pixels on the camera).

It is also possible to evaluate it in the height direction:

R=Ry=(height of the image in pixels on the miniature screen)/(height of the image in pixels on the camera).

It is also possible to take the average over both of them:

R=(Rx+Ry)/2

For example, for a VGA miniature screen:

|R|=640/A

where A is the number of pixels occupied by the optically-displayed image on the camera.

R can also be evaluated theoretically or practically by measuring the transverse magnification GYimager of the miniature screen and virtual image combination through the imager, and by measuring the transverse magnification GYcam of the virtual image and CCD camera combination through the objective lens of the camera.

The following then applies for a given camera:

P=PitchμD/(GYpipe·GYcam·PitchCCD)

where PitchpD is the size of a pixel of the miniature screen and PitchCCD is the size of a pixel of the camera detector.

These vectors VD and VG are then directed to the driver P of the miniature screens 3 and 4, and more particularly to specific circuits dedicated to compensating the right-left alignment offset CC. There are two of these circuits, one for each miniature screen, and they serve firstly to store the values of the correction vectors VD and VG respectively, and secondly to transform the output signal from the primary display circuit PA as a function of said correction vectors.

Each primary display driver or circuit PA addresses the screen pixels from the data of the image for display and redirects its output data towards the compensation circuit CC.

FIG. 6 shows the hardware architecture for implementing this protocol.

This figure shows only one miniature screen 3.

A computer controlling the alignment bench 20 is connected to a correction vector transfer unit 21 that is connected to a memory 23 of the driver P to the screen 3. The computer is also connected to a memory control channel 22 including a reset unit for resetting the correction vector stored in the memory unit 23 of the compensation circuit CC and an adder for adding the value of the correction vector to the value stored in said memory unit 23.

An image display offset circuit 24 serves to shift an image IM delivered by the source S to the display driver or circuit PA by an amount corresponding to the correction vector stored in the memory unit 23. This circuit 24 delivers the offset image IE to the miniature screen 3.

By performing successive alignment loops, it is possible to obtain better accuracy, compensating the non-linearities of the magnifications of the optical systems.

In practice, it suffices to add the correction vectors of the successive iteration loops in order to obtain a value that is more and more accurate.

FIG. 7 is a face view of a miniature screen in accordance with the invention.

It is important for the size of the working zone ZU of the screen 3 to be appropriately dimensioned. When performing alignment, this size determines the available adjustment range. It is therefore necessary to determine it in such a manner as to be certain always to have enough pixels available for moving the image so as to achieve fusion between the left image I1 and the right image I2.

This adjustment range depends on the opto-mechanical tolerance budget of the system for fusing the two images, and on the characteristics of the optical system for magnifying the image, e.g. the imager 1.

It is possible to shift this range when moving the image. The calculation depends on features specific to the opto-mechanical system. The final result can be directly transposed to the present system since the number of additional pixels required on each side is given by:

Np=Delta/PitchμD

when the stroke of the screen is expressed in the form ±Delta.

In practice, the value of Delta and/or the value of Pitch, and thus the value of Np along the X axis may differ from the values along the Y axis of the miniature screen.

The screen thus presents an active surface of geometry as shown in FIG. 7, in which:

Lp=Np·Pitch_{—}μD

Hf=NHf·Pitch_{—}μD

Lf=NLf·Pitch_{—}μD

where NHf and NLf are the dimensions of the display in pixels, e.g. respectively 480 and 640 for a VGA format.

In the portion of the working zone ZU where the image IE is not displayed, the pixels are addressed in such a manner as to be opaque and black.

It is also appropriate to verify that adjustment by shifting pixels is sufficiently sensitive to be capable of causing the virtual images I1 and I2 to fuse, given the final tolerances.

If the greatest tolerable mismatch angle is written alpha, then the capability of the electronic system for adjusting fusion is expressed as follows:

C=EFLpipe·alpha/Pitch_{—}μD

where EFL is the effective focus and Pitch_μD is the size of the pixel.

By way of example, ELF=20 mm, alpha=0.5 Δ, Pitch_μD=10 μm, and the resulting capability of the system is C=9, which is a good result.

If it is desired to have capability of at least 4, it is necessary to select a screen with a pixel size of less than 22.5 μm.

FIG. 8 shows the same alignment algorithm protocol as shown above in FIG. 5, but applied to another type of binocular display.

Below, the word “lens” is used to designate in particular an optionally correcting lens for mounting in an eyeglass frame. An ophthalmic lens presents traditional functions including correcting eyesight, and functions against reflection, dirtying, and scratching, for example.

The invention may also be applied to a binocular display with an imager 1, 2 that is integrated in each of the lenses LG, LD of a pair of ophthalmic eyeglasses, receiving a light beam from respective beam generator devices GG, GD that include respective miniature screens 3, 4 and respective beam-processing arrangements of the type including a mirror and a lens. It is then the frame M that needs to satisfy the mechanical requirements of the method of maintaining the alignment of the binocular display.

The bench used is similar to that described above with the sole difference that it is possible to vary the pupillary distance between the cameras C1, C2, i.e. to adjust the distance between these two cameras.

For each value of the pupillary half-distance, there corresponds a calibration value (Xc, Yc).

Thus, a data set (Xc, Yc)=f(pupillary half-distance) is stored in the memory of a computer controlling the alignment bench for each of the right and left sides once the bench has been calibrated.

With this system, it is thus possible to adjust fusion of the right and left images, and also to completely personalize fusion of the right and left images as a function on the pupillary distance of the wearer.

The principle is the same as that described above, each of the right and left generator devices GD and GG having its own alignment adjustment value for a given pupillary distance of the wearer together with a specific correction vector stored in memory.

The range over which the image can be shifted electronically on the screen is calculated on the same principle as above: as a function of tolerances on all the mechanical and optical variations in the system. These tolerances are compensated by the electronic shifting, and storing the correction value in a memory in the memory unit serves to ensure that the adjustment is correct for the wearer on each utilization.

In order to ensure that this is so, it is possible for the memory unit to be associated with a system for checking and correcting error. This adjustment data is of very great importance for visual comfort and health.

For example, it is possible to use redundant storage of the information with ongoing comparison and an error correction code.

Switching off or replacing batteries should not be clear the memory unit storing this crucial information.

For this purpose, the control circuits of binocular eyeglasses are provided either with a secondary energy source, e.g. a secondary battery for the purpose of maintaining the information stored in volatile memory, or else they are provided with memory components that are not volatile.

More generally, any device known to the person skilled in the art for keeping information in memory after switching off can be used, for example long-duration lithium type batteries or read-only memories, non-volatile memories, etc., that do not need to be electrically powered in order to maintain their state.

The invention relates in particular to the driver P as mentioned above.

The driver is shown in FIGS. 9 and 10. It is placed in a unit 30 provided with a first connection P1 for communication with a computer O, e.g. a female USB connector for receiving a corresponding USB plug C, a second connection P2 for inputting data coming from an image source S, e.g. a female connector designed to receive an external analog or digital video source, and a third connection P3 to said right and left screens of the display A. The computer O is preferably the computer for controlling the alignment bench 20 or some other computer storing in memory the data from the computer controlling the alignment bench 20.

The computer, the image source, and the display may be connected to the driver either via wires or else wirelessly.

By way of example, the unit is in the form of a rectangular parallelepiped, e.g. having maximum dimensions as follows: length 90 mm; width 55 mm; and height 10 mm. Its maximum weight may be 200 grams (g). In a variant, the driver may also be incorporated in a unit of an arrangement for generating images that is secured, optionally removably, to a display A.

The driver also includes a control arrangement 31 of the multidirectional joystick type that enables the user to configure the behavior of the driver. A button is provided on the driver unit P serving to lock its control arrangement, so as to avoid any undesired action.

This control arrangement 31 forms part of a man/machine interface enabling a user to select a personalized compensation profile. This man/machine interface can also make it possible for a user to select a mode of de-interlacing.

The first connection P1 also serves to connect the driver to an AC or DC power supply via a suitable USB power adapter a1, a2.

As mentioned above, the driver comprises a compensation circuit CC and an offset circuit 24 for shifting an image IM transmitted from said source S, and prior to delivery to the display circuit PA of said screen.

The compensation circuit is constituted essentially by a central processor unit (CPU) that controls the general operation of the driver and in particular serves to:
initialize the driver on switching on and reinitialize it when values are changed:
manage USB communication with the computer O;
perform a file management function;
perform a video loop management function;
perform an electronic compensation management function; and
perform the above-mentioned man/machine interface management function.

The functions of the CPU are described in greater detail with reference to FIG. 11 which is a diagram showing the data streams therethrough.

The function of managing USB communication enables it to communicate with the computer O. It delivers thereto the various driver information descriptors that are contained in the executable code of the micro software of the CPU function, and a communications protocol application is put into place by means of two both-way USB communications channels, a control channel that enables the computer to configure and inspect the functions of the driver, and a mass-transfer channel that is dedicated mainly to transferring images between the computer and the driver.

The file management function serves to store files in flash random access memories, to read images stored in those memories, to search for files stored in the memories, and to delete files stored in the memories.

The video loop management function serves to test the entire system for acquiring, processing, and generating video images of the driver in the absence of an external video signal. It consists in generating a video signal with a still test image and in injecting it upstream from the video acquisition system via a multiplexer referenced “Video Mux”. It controls the multiplexer. It causes the test image transmitted by the computer to be loaded, stores it in a memory of the driver, returns it, and causes it to be read by the flash memories, using file management.

The function of managing electronic compensation returns and reads data from a file containing electronic compensation parameter data and parameter data for formulas that enable the values of the compensation vectors to be recalculated, thus enabling reliable error checking to be performed on the content of the file stored in the flash memories, via the file management function.

Storing the compensation parameters involves associating a user identifier with a personalized compensation profile.

In order to verify and guarantee the integrity of the compensation data each time the display is used, on initialization of the system this function always performs a corrective error check on the content of this file by default.

Corrective error checking is performed on the following principle.

During preparation of the display, the file is made redundant and copied into two flash memories ORD and BRD via the USB bus.

When the system is initialized, the electronic compensation management function returns and reads the data in the two default redundant files stored in the memories, and for each of them it recalculates the components of the recalculated left and right compensation vectors, e.g. using the following formulas:

$${V}_{gORD \text{/} BRD} = - {( \begin{matrix}E [ \begin{matrix}E ( ( {Xi}_{g} - {Xc}_{g} ) \cdot {Rx}_{g} \cdot cos ( α {c}_{g} ) ) + \\ E ( ( {Yi}_{g} - {Yc}_{g} ) \cdot {Ry}_{g} \cdot sin ( α {c}_{g} ) )\end{matrix} ] \\ E [ \begin{matrix}- E ( ( {Xi}_{g} - {Xc}_{g} ) \cdot {Rx}_{g} \cdot sin ( α {c}_{g} ) ) + \\ E ( ( {Yi}_{g} - {Yc}_{g} ) \cdot {Ry}_{g} \cdot cos ( α {c}_{g} ) )\end{matrix} ] \\ α {c}_{g}\end{matrix} )}_{ORD \text{/} BRD}$$

$${V}_{dORD \text{/} BRD} = - {( \begin{matrix}E [ \begin{matrix}E ( ( {Xi}_{d} - {Xc}_{d} ) \cdot {Rx}_{d} \cdot cos ( α {c}_{d} ) ) + \\ E ( ( {Yi}_{d} - {Yc}_{d} ) \cdot {Ry}_{d} \cdot sin ( α {c}_{d} ) )\end{matrix} ] \\ E [ \begin{matrix}- E ( ( {Xi}_{d} - {Xc}_{d} ) \cdot {Rx}_{d} \cdot sin ( α {c}_{d} ) ) + \\ E ( ( {Yi}_{d} - {Yc}_{d} ) \cdot {Ry}_{d} \cdot cos ( α {c}_{d} ) )\end{matrix} ] \\ α {c}_{d}\end{matrix} )}_{ORD \text{/} BRD}$$

where:

V_{g ORD/BRD}, V_{d ORD/BRD} are the recalculated left and right compensation vectors for the memories ORD and BRD respectively;

αc_{g}, αc_{d} are the left and right compensation angles;

Xi_{g}, Yi_{g}, Xi_{d}, Xi_{d} are the positions of the centers of the charts identified in the left and right images coming from the binocular eyeglasses;

Xc_{g}, Yc_{g}, Xc_{d}, Yc_{d} are the positions of the centers of the charts identified in the left and right images coming from the bench calibration chart; and
Rx_{g}, Ry_{g}, Rx_{d}, Ry_{d} are the left and right magnification parameters.

The compensation vectors stored in the memories ORD and BRD are defined as follows:

$${VCG}_{ORD \text{/} BRD} = {( \begin{matrix}DX\_G \\ DY\_G \\ THETA\_G\end{matrix} )}_{ORD / BRD}$$

$$and$$

$${VCD}_{ORD \text{/} BRD} = {( \begin{matrix}DX\_D \\ DY\_D \\ THETA\_D\end{matrix} )}_{ORD / BRD}$$

The unit is in nominal operation if, and only if:

VCG_{BRD}=VCG_{BRD} and VCD_{BRD}=VCD_{BRD}

The unit is in retrievable error operation if, and only if:
condition 1 is false; and
the formula can recover the values stored in one of the two memories, i.e.:

V_{g ORD}=VCG_{BRD} and V_{d ORD}=VCD_{ORD}

or

V_{g BRD}=VCG_{BRD} and V_{d BRD}=VCD_{BRD}

The file on the faulty memory is then replaced by the file from the correct memory.

Under all other circumstances, the following procedure is performed.

If

$${V}_{g} = ( \begin{matrix}DX\_G \\ DY\_G\end{matrix} ) and {V}_{d} = ( \begin{matrix}DX\_D \\ DY\_D\end{matrix} )$$

for both redundant files, then the compensation data is considered as being valid and error processing is terminated.

If

$${V}_{g} \neq ( \begin{matrix}DX\_G \\ DY\_G\end{matrix} ) or {V}_{d} \neq ( \begin{matrix}DX\_D \\ DY\_D\end{matrix} )$$

for one of the two redundant files FPCE, then the function of managing electronic compensation overwrites the erroneous files stored in flash memory and replaces it with the valid redundant file.

If

$${V}_{g} \neq ( \begin{matrix}DX\_G \\ DY\_G\end{matrix} ) or {V}_{d} \neq ( \begin{matrix}DX\_D \\ DY\_D\end{matrix} )$$

for both redundant files, then the compensation data is considered as being invalid and the message “ERROR” is displayed on a black background in the centers of the miniature screens.

If one of the two redundant files is valid, then the electronic compensation management function transmits to a graphics processing unit (GPU) the data needed for video processing, on the basis of valid compensation parameters.

The driver thus includes a multiplexer “Video Mux” as mentioned above that performs analog multiplexing between the incoming video signal from the connection P2 and the video looping signal generated by a video encoder. The video signal that results from the multiplexing is transmitted to a video decoder. The multiplexing control is generated by the CPU.

The driver also includes the video decoder that acquires the analog video signal output from the multiplexer and converts this signal into a standard digital video format that can be processed by the GPU. The video decoder switches automatically between PAL and NTSC modes, depending on the nature of the incoming video signal.

If the video is input directly in digital format, then the video decoding function does not exist. The GPU then processes directly the digital format transmitted by the multiplexer. Nevertheless, digital formats are not yet very standardized, and it is assumed in the description below that it is an analog signal that is received from the information source S.

The display offset circuit 24 is constituted essentially by the above-mentioned GPU which performs the following:
a video acquisition function;
an image processing function;
a video generation function; and
a chart generation function.

These functions of the GPU are described in detail with reference to FIG. 12 which is a diagram of the data streams therethrough.

The GPU continuously detects the presence of a valid video signal output from a video decoder. If there is no signal or if the video signal is not valid, then the message “NO SIGNAL” is displayed on a black background in the centers of the miniature screens.

The GPU also warns the CPU as soon as it detects or loses a valid video signal, so that the CPU can immediately refresh the values accordingly.

The video acquisition function acts in real time to acquire the digital video signal at the output from the analog-to-digital decoder (ADC) of the video decoder.

The acquisition task consists in extracting the image data from the video signal and in preparing it for the image processing function associated with the CPU.

The image processing function acts continuously and in real time to perform electronic compensation of the display using the method of electronically shifting the video images on the active surfaces of the miniature screens.

The optical correction by electronic compensation consists in continuously and in real time applying to each video image acquired by the video acquisition function a distinct image processing function for each of the left and right video channels. The result of this treatment is delivered to the video generator function for applying to the graphics controllers.

The left and right video channels are subjected to the same image processing algorithm, but the parameters used by the algorithm are specific to each video channel.

The image processing function is performed using the following operations in this order:
common de-interlacing of both video channels;
common definition conversion of both video channels;
rotation specific to each video channel; and
shifting specific to each video channel.

Electronic compensation is activated automatically after the driver self-test stage.

The electronic compensation performed by the image processing function can be activated or inhibited. When the electronic compensation function is inhibited, it is only the operations of rotation and shifting that are deactivated: these two operations are then put into a bypass mode, and the video image that is output is the image resulting from the centering operation.

The electronic compensation is activated automatically by default as soon as the appliance is switched on.

When viewing a video sequence including moving subjects or background, stripe type defects may appear in the image if the video has been subjected to TV interlacing (at the source, or during post-encoding), and has not subsequently been de-interlaced.

In order to solve this problem, the driver may incorporate a sophisticated de-interlacing function enabling it to go from interlaced video mode to progressive video mode while correcting for the losses due to TV interlacing.

The compensation operations (shifting and rotation) are defined in an affine Euclidean plane with a rectangular frame of reference (Ox, Oy) that presents the following characteristics:
the axis Oy of the frame of reference is parallel to the left and right sides of the active surface of the miniature screen; and
the origin O of the frame of reference is the center of the active surface of the miniature screen.

In order to avoid accumulating position errors, the shifting and rotation parameters are expressed absolutely relative to the reference position of the reduced useful video image, which corresponds to the position at which the useful video is centered in the active surface of the miniature screen after its definition has been reduced.

Thus, once reduced, the useful video image is always centered within the working surface prior to being subjected to the operations of rotation and shifting that are specific to each video channel.

Once the useful video image has been centered, the image processing function, where necessary, compensates angular defects between the left and right images by inclining the useful video image on the active surface of each of the miniature screens.

The inclination of the useful image is defined in the rectangular frame of reference (Ox, Oy) of the working surface by an affine rotation of center O and an angle θ.

The rotation operation is distinct for each video channel.

The rotation parameters are stored in the files.

After an optional rotation operation, the image processing function then, where necessary, performs alignment by shifting the useful video image horizontally and/or vertically over the active surface of each of the miniature screens.

The offset of the useful image is defined in the rectangular frame of reference of the working surface by shifting by the vector

$${V}_{t} = ( \begin{matrix}δ x \\ δ y\end{matrix} ) .$$

The parameters of the offset are stored in the files.

The video generation function acts in real time to encode in the Square Pixel format the left and right video images generated by the image processing function, and it transmits the video images that result from the encoding to the graphics controllers of a VGA controller.

The chart generation function serves to generate a static image in VGA format (640p(w)×480p(h)) in a digital video format that is compatible with the video encoder.

The driver has three flash memories, some of which are mentioned above: the original redundant drive (ORD) and backup redundant drive (BRD) flash memories constituting the redundant memories that contain, amongst other things, the system configuration file and the above-mentioned files, and a mass storage drive (MSD) flash memory, which is a mass storage memory that contains, amongst other things, the test charts used for the video looping function.

The driver also includes a power supply function that produces the power supply signals needed by the electronic functions of the driver and that manages electrical recharging of a battery.

The power delivered by the USB bus and shown in FIG. 10 is used mainly for in situ electrical recharging of the battery of the driver, i.e. without it being necessary to open the unit and extract the battery therefrom.

FIG. 13 is a block diagram showing the electronics of the driver P in accordance with the invention as connected to a display A.

This figure shows the first connection P1 for communication with a computer O or 20 associated with its USB interface, the second connection P2 for inputting data coming from an image source S, and the third connection P3 for connecting to said right and left screens 4 and 3 of the display A.

It should be observed that the image source S may be separate from the driver P as shown, and that it can equally well be incorporated in the electronic architecture of the driver, being contained in the same unit.

The essential components mentioned above and their connections are also shown, specifically the CPU, the GPU, the multiplexer “Video Mux”, the video decoder, the video encoder, the man/machine interface “MMI”, the graphics controllers “VGA”, the set of memories “Flash Eprom” and “RAM”, the battery, and the power supplies.

When the video decoder is not physically incorporated in the CPU, as shown, the decoder must be configurable by the I2C protocol via the I2C network bus that is arbitrated by the function I “I2C interface”.

The mass storage memory contains amongst other things the test chart and it is interfaced via an “SPI UART” interface using a fast bus of the SPI type.

1. A driver for driving miniature screens of a binocular display that comprises, for each eye of the wearer, a respective optical imager for shaping light beams corresponding to an image of determined surface area delivered by a said miniature screen and for directing them to the eye of the wearer so as to enable information content contained in a virtual image to be viewed, the driver is placed in a unit provided with:
a first connection for communication with a computer having memory storing compensation parameters necessary for shifting the images delivered by the screens so as to obtain an adjusted position for said images on said screens corresponding to the two virtual images being superposed;
a second connection for inputting data coming from an image source; and
a third connection connecting to said right and left screens of the display.

2. A driver according to claim 1, comprising a compensation circuit (CC) and an offset circuit (24) for shifting the display of an image (IM) transmitted from said source (S) to the display circuit (PA) of said screen.

3. A driver according to claim 1, said compensation circuit comprises a CPU performing a compensation management function including storing in memory said compensation parameters together with parameters of formulas for calculating said compensation parameters.

4. A driver according to claim 3, wherein said CPU checks said compensation parameters for error and corrects them.

5. A driver according to claim 4, wherein said CPU also performs a video looping function including generating a stationary test image previously stored in the driver by said computer.

6. A driver according to claim 3, wherein the compensation parameters stored in memory are associated with a user identifier in a personalized compensation profile.

7. A driver according to claim 2, wherein said offset circuit comprises a GPU performing an image processing function that continuously shifts the image electronically in real time.

8. A driver according to claim 7, wherein said image processing function including performing image rotation specific to each miniature screen and image shifting specific to each miniature screen.

9. A driver according to claim 7, wherein said image processing function also includes image de-interlacing common to both miniature screens.

10. A driver according to claim 6, including a man/machine interface enabling a user to select a personalized compensation profile.

11. A driver according to claim 9, wherein said man/machine interface enables a user to select a de-interlacing mode.

12. A method of determining said compensation parameters needed for shifting the images delivered by the screens, the method comprising: recording said compensation parameters in said driver according to claim 1, and in using at least one or two cameras that can be positioned so that the entry pupil(s) of the objective lens(es) thereof lie in the vicinity of the positions of the pupils of respective eyes of the wearer.

13. A method according to claim 12, including first step of calibration including storing in memory the calibration coordinates of the center of a target (CI) relative to the optical axis of each camera.

14. A method according to claim 13, wherein two cameras (C1, C2) are used, and in that it includes a prior step of converging the optical axes of said cameras on said common target (CI).

15. A method according to claim 12, further comprising the step of installing said display in front of said cameras, each of the two miniature screens delivering a said image of determined surface area, and the method including the following steps for each camera:
acquiring the image;
calculating the center of the image; and
calculating the correction vector present between said image center and the optical axis of the camera, taking account of said calibration coordinates.

16. A method according to claim 15, further comprising the step of recording said correction vectors in a compensation circuit of said driver.

17. Apparatus for implementing the method of claim 16, said apparatus comprising a computer controlling an alignment bench for connection to said driver.

18. A binocular display comprising, for each eye of the wearer:
an optical imager for shaping light beams corresponding to an image of determined surface area delivered by a respective one of said miniature screens, and for directing the light beams towards each eye of the wearer in order to enable information content contained in a virtual image to be viewed, wherein the display is associated with a driver according to claim 1.

19. A display according to claim 18, including an imager integrated in each lens of a pair of eyeglasses and receiving light beams from respective beam generator devices, each comprising a said miniature screen.
